(19) United States
(12) Patent Application Publication
(10) Pub. No.: US 2014/0287062 A1
(43) Pub. Date: Sep. 25, 2014

(54) Powder Composition for the Disinfection of Ungulates Baths

(71) Applicant: I.C.F.. S.r.L., Palazzo Pignano (IT)

(72) Inventors: Fabio Gelmi, Cremona (IT); Maurizio Venturini, Cremona (IT)

(73) Assignee: I.C.F. S.r.L., Palazzo Pignano (IT)

(21) Appl. No.: 14/363,666

(22) PCT Filed: Dec. 5, 2012
(86) PCT No.: PCT/EP2012/074464

§ 371 Date: Jun. 6, 2014

(30) Foreign Application Priority Data
Dec. 6, 2011 (BR) PI1105614-2

(51) Int. Cl. A01N 43/66; A01N 59/20

(52) U.S. Cl. CPC A01N 43/66; A01N 59/20
USPC 424/637

(57) ABSTRACT

A powder composition for the disinfection of ungulates' baths is disclosed. In particular the present invention relates to the use of a powder composition as a disinfecting agent for the preparation of the baths suitable for ungulates' prophylaxis. It comprises at least one chlorinated organic compound, copper sulphate, EDTA, a natural gum and an inorganic carbonate at specific weight percentages.

### FIELD OF THE INVENTION

The present invention relates to a powder composition as a disinfecting agent for disinfecting bath for ungulates' hooves. In particular, the present invention relates to the use of a powder composition as a disinfecting agent for the preparation of the baths suitable for ungulates' prophylaxis.

### STATE OF THE ART

In the state of the art, the treatment of animal foot diseases, such as the treatment of abscesses (white line disease), the treatment of laminitis which involves oedema, haemorrhage and necrosis of the corium tissue, as well as the eradication of Bacteroides nodosus, the cause of irritating dermatitis which deteriorates into ulcers, is based on local therapies which employ products based on quaternary ammonium salts, peracetic acid, formalin, paraformaldehyde, copper sulphate and organic chlorine-based compounds. The organic chlorine-based compounds perform wide spectrum antibacterial action and are used in the preparation of many products, whose proven bacteriostatic, bactericidal, antifungal and antiviral action is used along with their capacity to prevent and slow down foot diseases.

Organic chlorine-based products are also used in preparations intended for human use such as skin disinfectants. In the veterinary field, the use of organic chlorine-based compositions, known in the state of the art for treating animal foot diseases, has various drawbacks mainly ascribable to high dosages needed to obtain significant beneficial effects.

A first drawback associated with the use of organic chlorine compounds at high dosages derives, for example, from the irritating and inflammatory effect on the animals' hooves and skin; moreover, if inhaled it is irritating to the animals' airways. The onset of said side effects can force treatment to be suspended before the desired results have been achieved.

A second drawback associated with the use of the known organic chlorine-based compositions, is associated with the fact that a high dosage thereof can also lead to irritating and inflammatory effects on the user during product use.

In the veterinary field, peracetic acid-based compounds, known in the state of the art for treating animal foot diseases, present the drawback of releasing acetic acid which has an irritant effect. Also, preparations of this type are not very stable. Again in the veterinary field, formalin-based products, known in the art for treating animal foot diseases, present the drawback of containing an active principle with mutagenic characteristics. Again in the veterinary field, copper sulphate-based products, known in the state of the art for treating animal foot diseases, present the drawback that at high dosages, copper sulphate is difficult to dispose of as being poorly bio-degradable and leading to a persistent build-up in the soil.

The object of the present invention is to provide a product that is effective for the disinfection of the baths used for ungulates' prophylaxis, so as to avoid the onset of the above mentioned animal foot diseases, that at the same time enables the relevant drawbacks of the known products to be overcome.

### SUMMARY OF THE INVENTION

The above indicated object has been achieved by a powder composition comprising:
a) from 10 to 40% by weight on the total composition weight, of at least one chlorinated organic compound selected from the group consisting of chlorinated isocyanuric acid or its salts, aromatic chloro-sulphonamide or its salts, and mixtures thereof,
b) from 0 to 30% by weight on the total composition weight, of copper sulphate,
c) from 1 to 20% by weight on the total composition weight, of EDTA or its salt,
d) from 30 to 75% by weight on the total composition weight, of a natural gum,
e) from 0 to 6% by weight of an inorganic carbonate, and
   veterinarily acceptable adjuvants and/or excipients, to be used as a disinfecting agent for the disinfection of the baths used for ungulates' profilaxis.

The characteristics and advantages of the present invention will be evident from the detailed description given below, and from the illustrative non-limiting working examples.

### DETAILED DESCRIPTION OF THE INVENTION

The invention therefore relates to the non-medical use of a powder composition as a disinfecting agent for the disinfection of the baths used for ungulates' profilaxis, said powder composition comprising:
a) from 10 to 40% by weight on the total composition weight, of at least one chlorinated organic compound selected from the group consisting of chlorinated isocyanuric acid or its salts, aromatic chloro-sulphonamide or its salts, and mixtures thereof,
b) from 0 to 30% by weight on the total composition weight, of copper sulphate,
c) from 1 to 20% by weight on the total composition weight, of EDTA or its salt,
d) from 30 to 75% by weight on the total composition weight, of a natural gum,
e) from 0 to 6% by weight of an inorganic carbonate, and
   veterinarily acceptable adjuvants and/or excipients.

In fact, it has been surprisingly found that the powder composition of the invention in hooves' baths, significantly enables highly satisfying results to be attained in disinfecting surfaces and apparatus composing the baths, at the same time without damaging the same, so as to suitably prevent animal hoof infections and inflammatory states of the hoof.

Said surfaces and apparatus can be made of metals, steel, polymers, such as polyethylene and PVC, elastomers, or combinations thereof.

Said ungulates are preferably cattle, cows, buffalo, horses, sheep, goats and pigs. In order to disinfect the bath, the powder composition is previously dispersed in an aqueous medium, preferably water, to form a high viscosity gel.

A further advantage of the powder composition is the high stability of chlorinated organic compounds compared to that of the same compounds but in aqueous solution. This means that the shelf life of this composition is greatly and significantly increased, not only with respect to the corresponding aqueous solutions, but also with respect to known products.

Hence, it has surprisingly been found that by combining a natural gum, a chlorinated organic compound, and EDTA in suitable weight percentages, a powder composition for veterinary use can be obtained having a high disinfecting efficacy, surprisingly at very low dosages.

In a preferred embodiment, said chlorinated organic compound is selected from the group consisting of trichloroisocyanuric acid, sodium trichloroisocyanurate, sodium dichloroisocyanurate, Chloramine T and mixtures thereof.

Preferably, the powder composition of the invention comprises from 15 to 45% by weight of said at least one organic chlorine compound or a derivative thereof, more preferably from 25 to 40% by weight.

Preferably, in said powder composition, EDTA or its salt is present, wherein said salt is preferably chosen from EDTA disodium salt and EDTA tetrasodium salt. In a preferred embodiment, the powder composition comprises tetrasodium salt (Na₄EDTA).

Preferably, the composition of the invention comprises from 4 to 15% by weight of said EDTA or its salt, more preferably from 4 to 13% by weight.

Preferably, the powder composition comprises from 35 to 70% by weight of natural gum, preferably from 40 to 60% by weight. Said natural gum is preferably selected from the group consisting of gum Arabic, tragacanth, guar gum, and xanthan gum.

In a preferred embodiment, said natural gum is xanthan gum.

It has been surprisingly found that the presence of natural gum generates a gel on mixing the powder with an aqueous medium. The gel consistency of the composition of the invention increases the contact time to surfaces and apparatus, thereby enhancing the action of organic chlorine compounds and their derivatives, copper sulphate and EDTA, hence enabling these compounds, for the same disinfecting efficacy, to be used in advantageously and significantly lower amounts, thus advantageously drastically reducing the environmental impact.

The composition can also comprise inorganic carbonate, which is chosen from ammonium carbonate, barium carbonate, cadmium carbonate, calcium carbonate, caesium carbonate, lithium carbonate, magnesium carbonate, manganese carbonate, lead carbonate, potassium carbonate, sodium carbonate, strontium carbonate and mixtures thereof.

Preferably, the powder composition further comprises a powder dyeing agent. After mixing the composition with an aqueous medium prior to use, said dyeing agent advantageously confers an intense colour thereto, thus enabling the treated surfaces to be marked. More preferably, said dyeing agent presents an intense blue colour when in water. In the composition of the invention, the dyeing agent is present in an amount from 0.01 to 20% by weight on the total composition weight, preferably from 0.1 to 10%, more preferably from 1 to 5%.

The dosage in the use of the composition of the present invention is dependent on the degree of disinfection to be achieved. Preferably, the powder composition is dispersed in foot baths at a dilution such that the active chlorine concentration is at least 250 ppm, preferably at least 1000 ppm. The treatment is then preferably carried out by setting a contact time of at least 5 minutes to surfaces and apparatus.

In a preferred embodiment, the powder composition for the previously described use of the invention consists of:
25 to 35% by weight of trichloroisocyanuric acid or its salt in powder form,
5 to 15% by weight of EDTA sodium salt,
45 to 60% by weight of xanthan gum,
0 to 5% by weight of sodium or potassium carbonate, and
2 to 5% by weight of dyeing agent.

In a particularly preferred embodiment, the powder composition for the previously described use of the invention consists of:
27 to 30% by weight of trichloroisocyanuric acid or its salt in powder form,
8 to 13% by weight of EDTA sodium salt,
53 to 57% by weight of xanthan gum,
2 to 4% by weight of sodium or potassium carbonate, and
2 to 4% by weight of dyeing agent.

The powder compositions of the present invention are prepared by mixing powder compounds in the aforedefined weight ratios.

Working examples of the present invention provided for illustrative purposes are reported herein below.

### EXAMPLE 1

In accordance with the present invention, 100 g of a composition for veterinary use in powder form were prepared by mixing:
50.63 g of xanthan gum,
29.77 g of trichloroisocyanuric acid powder,
11.58 g of copper sulphate,
4.86 g of EDTA tetrasodium salt,
3.16 g of dyeing agent.

The composition was then diluted in water until the active chlorine concentration is at least 800 ppm. The resulting solution was used for disinfecting hoof baths of horses.

### EXAMPLE 2

In accordance with the present invention, 12.5 kg of a composition for veterinary use in powder form were prepared by mixing:
6.988 kg of xanthan gum,
3.5 kg of trichloroisocyanuric acid powder,
1.1175 kg of EDTA,
0.395 kg of ferric ammonium ferrocyanide dyeing agent (Unipure Blue LC685), and
0.50 kg of sodium carbonate.

The composition was then diluted in water until the active chlorine concentration is at least 500 ppm. The resulting solution was used for disinfecting hoof baths of adult cows.

### EXAMPLE 3

In accordance with the present invention, 2.5 kg of a composition for veterinary use in powder form were prepared by mixing:
1.26575 kg of xanthan gum,
0.74425 kg of trichloroisocyanuric acid powder,
0.411 kg of EDTA,
0.079 kg of ferric ammonium ferrocyanide dyeing agent (Unipure Blue LC685).

The composition was then diluted in water until the active chlorine concentration is at least 1500 ppm. The resulting solution was used for disinfecting hoof baths of sheeps.

1. A method of disinfecting a bath used for the prophylactic treatment of ungulates, said method comprising:
i. providing a disinfecting powder composition comprising:
a) from 10 to 40% by weight of the total composition weight, of at least one chlorinated organic compound selected from the group consisting of chlorinated isocyanuric acid or its salts, aromatic chloro-sulphonamide or its salts, and mixtures thereof,
b) from 0 to 30% by weight of the total composition weight, of copper sulphate,
c) from 1 to 20% by weight of the total composition weight, of EDTA or its salt,
d) from 30 to 75% by weight of the total composition weight, of a natural gum,
e) from 0 to 6% by weight of an inorganic carbonate, and
veterinarily acceptable adjuvants and/or excipients; and
ii. applying the powder composition to the bath.

2. The method of claim 1, wherein the powder composition is dissolved in an aqueous medium to form a gel, prior to the disinfection of the bath.

3. The method of claim 2, wherein said powder composition is dissolved in the aqueous medium until a concentration of at least 250 ppm of chlorine is obtained.

4. The method of claim 2, wherein said powder composition is dissolved in the aqueous medium until a concentration of at least 1000 ppm of chlorine is obtained.

5. The method of claim 1, wherein, in said powder composition, said at least one chlorinated organic compound is selected from the group consisting of sodium trichloroisocyanurate, sodium dichloroisocyanurate, Chloramine T and mixtures thereof.

6. The method of claim 1, wherein said powder composition comprises from 25 to 40% by weight of said at least one chlorinated organic compound.

7. The method of claim 1, wherein said powder composition comprises from 4 to 15% by weight of said EDTA or its salt.

8. The method of claim 1, wherein said powder composition comprises from 35 to 70% by weight of said natural gum.

9. The method of claim 1, wherein, in said powder composition, said natural gum is selected from the group consisting of gum Arabic, tragacanth, guar gum, and xanthan gum.

10. The method of claim 1, wherein, in said powder composition, said inorganic carbonate is ammonium carbonate, barium carbonate, cadmium carbonate, calcium carbonate, caesium carbonate, lithium carbonate, magnesium carbonate, manganese carbonate, lead carbonate, potassium carbonate, sodium carbonate, strontium carbonate or a mixture thereof.

11. The method of claim 1, wherein said powder composition further comprises a powder dyeing agent.

12. The method of claim 1, wherein said powder composition consists of:
25 to 35% by weight of sodium trichloroisocyanurate,
5 to 15% by weight of EDTA sodium salt,
45 to 60% by weight of xanthan gum,
0 to 5% by weight of sodium or potassium carbonate, and
2 to 5% by weight of a dyeing agent.

13. The method of claim 12, wherein said powder composition consists of:
27 to 30% by weight of sodium trichloroisocyanurate,
8 to 13% by weight of EDTA sodium salt,
53 to 57% by weight of xanthan gum,
2 to 4% by weight of sodium or potassium carbonate, and
2 to 4% by weight of the dyeing agent.

14. The method of claim 7, wherein said powder composition comprises from 4 to 13% by weight of said EDTA or its salt.

15. The method of claim 8, wherein said powder composition comprises from 40 to 60% by weight of said natural gum.
